(19) United States
(12) Patent Application Publication
(10) Pub. No.: US 2013/0191741 A1
(43) Pub. Date: Jul. 25, 2013

(54) Methods and Apparatus for Providing Feedback from an Electronic Device

(71) Applicants: Timothy Dickinson, Crystal Lake, IL (US); Rachid M. Alameh, Crystal Lake, IL (US); Jeong J. Ma, Long Grove, IL (US)

(72) Inventors: Timothy Dickinson, Crystal Lake, IL (US); Rachid M. Alameh, Crystal Lake, IL (US); Jeong J. Ma, Long Grove, IL (US)

(73) Assignee: Motorola Mobility, Inc., Libertyville, IL (US)

(21) Appl. No.: 13/356,757

(22) Filed: Jan. 24, 2012

(51) Int. Cl. G06F 3/048; G06F 3/03

(52) U.S. Cl. 715/702; 715/863

(57) ABSTRACT

An electronic device, which can be a wearable electronic device, tablet electronic device, or other type of device, includes a user interface operable to detect gesture input. A visible output, which can be proximately disposed with the user interface, provides visible feedback with which a user can determine that the input was received. A control circuit is operable in some embodiments to control the output of the visible output to mimic the gesture input. Audible feedback and tactile feedback can be used in addition to the visible feedback.

### BACKGROUND

1. Technical Field

This invention relates generally to electronic devices, and more particularly to feedback devices and methods in electronic devices.

2. Background Art

Electronic devices, such as mobile telephones, smart phones, gaming devices, and the like, present information to users on a display. As these devices have become more sophisticated, so too have their displays and the information that can be presented on them. For example, not too long ago a mobile phone included a rudimentary light emitting diode display capable of only presenting numbers and letters configured as seven-segment characters. Today, high-resolution liquid crystal and other displays included with mobile communication devices and smart phones can be capable of presenting high-resolution video.

Advances in electronic device design have resulting in many devices becoming smaller and smaller. Portable electronic devices that once were the size of a shoebox now fit easily in a pocket. The reduction in size of the overall device means that the displays and user interfaces have also gotten smaller. It is sometimes challenging, when using small user interfaces, to know whether input has been accurately or completely delivered to the electronic device. It would be advantageous to have an improved feedback mechanism.

### BRIEF DESCRIPTION OF THE DRAWINGS

FIG. 1 illustrates an explanatory electronic device having one illustrative feedback device configured in accordance with one or more embodiments of the invention.

FIG. 2 illustrates a schematic block diagram of the components in an electronic device pertinent to delivering feedback in accordance with one explanatory embodiment of the invention.

FIG. 3 illustrates another explanatory electronic device having one illustrative feedback device configured in accordance with one or more embodiments of the invention.

FIG. 4 illustrates another explanatory electronic device having one illustrative feedback device configured in accordance with one or more embodiments of the invention.

FIG. 5 illustrates a detachable electronic module having one explanatory feedback device configured in accordance with one or more embodiments of the invention.

FIG. 6 illustrates one embodiment of a wearable, active strap having one explanatory feedback device configured in accordance with one or more embodiments of the invention.

FIG. 7 illustrates a user employing a wearable electronic device having one explanatory feedback system configured in accordance with one or more embodiments of the invention.

FIG. 8 illustrates another user employing an alternate electronic device to control a remote electronic device, with the alternate electronic device having one explanatory feedback system configured in accordance with one or more embodiments of the invention.

FIG. 9 illustrates another electronic device having an explanatory feedback system configured in accordance with one or more embodiments of the invention.

FIG. 10 illustrates an accessory configured for operation with an electronic device, where the accessory is equipped with one explanatory feedback system configured in accordance with one or more embodiments of the invention.

FIG. 11 illustrates alternate feedback systems, suitable for use with an electronic device, and configured in accordance with one or more embodiments of the invention.

FIGS. 12-16 illustrate various configurations of visual feedback systems configured in accordance with embodiments of the invention.

FIG. 18 illustrates a user making a gesture as input for one explanatory electronic device having a feedback system configured in accordance with one or more embodiments of the invention.

FIG. 19 illustrates a user making another gesture as input for one explanatory electronic device having a feedback system configured in accordance with one or more embodiments of the invention.

FIG. 20 illustrates a user making another gesture as input for one explanatory electronic device having a feedback system configured in accordance with one or more embodiments of the invention.

FIG. 21 illustrates a user making another gesture as input for one explanatory electronic device having a feedback system configured in accordance with one or more embodiments of the invention.

FIG. 22 illustrates a user making another gesture as input for one explanatory electronic device having a feedback system configured in accordance with one or more embodiments of the invention.

FIG. 23 illustrates one explanatory electronic device operating in a first operational mode and having a feedback system configured in accordance with one or more embodiments of the invention.

FIG. 24 illustrates the explanatory electronic device of claim 23 entering a second operational mode in accordance with one or more embodiments of the invention in response to a user making a predetermined gesture as input for the explanatory device.

FIG. 25 illustrates the explanatory electronic device of claim 23 entering a third operational mode in accordance with one or more embodiments of the invention in response to a user making a predetermined gesture as input for the explanatory device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF EMBODIMENTS OF THE INVENTION

Before describing in detail embodiments that are in accordance with the present invention, it should be observed that the embodiments reside primarily in combinations of method steps and apparatus components related to delivering feedback to a user from an electronic device in response to receiving user input. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of actuating visible, tactile, and audible devices to provide user feedback in response to receiving tactile, gesture, or other user input as described herein. The non-processor circuits may include, but are not limited to, a radio receiver, a radio transmitter, near-field wireless transceivers, haptic devices, loudspeakers, illumination devices, signal drivers, clock circuits, power source circuits, and user input devices. As such, these functions may be interpreted as steps of a method to perform visible, audible, and/or tactile feedback to a user from an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide “off display” or “off user interface” visible devices to provide feedback to a user when input is entered into an electronic device via a touch-sensitive display or other user interface. The terms “off display” or “off user interface” are used to indicate that the visible feedback mechanism, while disposed proximately or adjacent with a display, touch-sensitive display, or other user interface, is separate from the display, touch-sensitive display, or other user interface. The visible device is used to provide feedback from areas outside the display, touch-sensitive display, or other user interface. Accordingly, when a user is covering large portions of a display while inputting data, an off display device can provide visible feedback when the data is received. In addition to visible feedback, embodiments of the present invention can provide acoustic feedback and/or tactile feedback as well.

While there are many electronic devices suitable for use with embodiments of the invention, one particular application well suited for use with embodiments described herein is that of “wearable” devices. Such devices are described generally in commonly assigned, co-pending U.S. application Ser. No.______ , entitled, “Methods and Devices for Clothing Detection about a Wearable Electronic Device,” Dickinson, et al., inventors, filed______, Attorney Docket No. CS38886, and U.S. application Ser. No.______, entitled, “Display Device, Corresponding Systems, and Methods for Orienting Output on a Display,” Dickinson, et al., inventors, filed______, Attorney Docket No. CS38820, and U.S. application Ser. No.______, entitled “Display Device, Corresponding Systems, and Methods Therefor, Attorney Docket No. CS38607, Cauwels et al., inventors, filed______, each of which are incorporated herein by reference for all purposes.

When using a wearable device, embodiments described herein contemplate that some such devices will have minimal display areas. These small displays, which can be touch-sensitive displays, may only be capable of presenting one or two lines of text as an example. Such small user interfaces can lead to obstructed views of the display, especially when trying to manipulate user actuation targets with a finger or other device. Feedback will be required to provide the user with an indication that input has been received. Even when other user input systems are used, such as infrared sensors or photographic detectors, such systems can be less intuitive than conventional touch-screen technology. Accordingly, real-time feedback will be beneficial to a user trying to interact with these other user input systems.

In one or more embodiments of the invention, a visible output is proximately disposed with the user interface. A control circuit, operable with the visible output, is configured to actuate the visible output when a user input detects a gesture or touch input. Illustrating by example, in situations where a touch-sensitive display is very small on a wearable device, a navigation light ring can be placed around the perimeter of the display. Such visible indicator can contain one or more segmented lights, each being selectively controllable by the control circuit. When a user interacts with the input system, be it a touch-sensitive surface, an infrared sensor configured to detect gesture input, or a photographic sensor configured to detect gesture input, the control circuit can be configured to selectively actuate one or more of the segmented lights such that the light ring glows or illuminates, thereby providing visible feedback. Since the visible output is off display or off user input, the user is still able to see the feedback despite covering all or most all of the display or user input.

The control circuit can be configured to alter the actuation of the segmented lights based upon nearness of the user input, accuracy of the user input, duration of the user input, force of the user input, direction of the user input, or other predefined or predetermined characteristics. For instance, the control circuit can be configured to vary the intensity of light, color of light, brightness of light, direction of light movement, depth of color, tint, or other factors to correspond with a detected, predetermined characteristic of the input. Light actuation can also be mapped to gesture length, position, or other characteristics to provide higher resolution feedback to the user.

In one or more embodiments, audio or tactile feedback can be used in conjunction with visible feedback. For example, when a user interacts with a touch-sensitive surface or other user interface device, an appropriate tone can be played from one or more audio output devices of the electronic device. Similarly, when the user is navigating in a particular direction, e.g., up, down, left, or right across the user interface, another audio sound can be produced. The inclusion of audio feedback allows the user to operate an electronic device without necessarily looking at the same—the equivalent of a Larry Byrd “no look” pass. In addition to, or instead of, audio, tactile feedback such as device vibration can be provided as well. Aspects of audio and tactile feedback can be varied, in one embodiment, so as to correspond with a user's gesture motion. For example, the audio and tactile feedback can be varied in intensity, volume (in the case of audio), frequency, or stereo spacing (also in the case of audio). Audio and tactile feedback provides for “eyes-free” operation, which can be desirable in sporting or other applications. Eyes-free operation can also be desirable from a safety perspective.

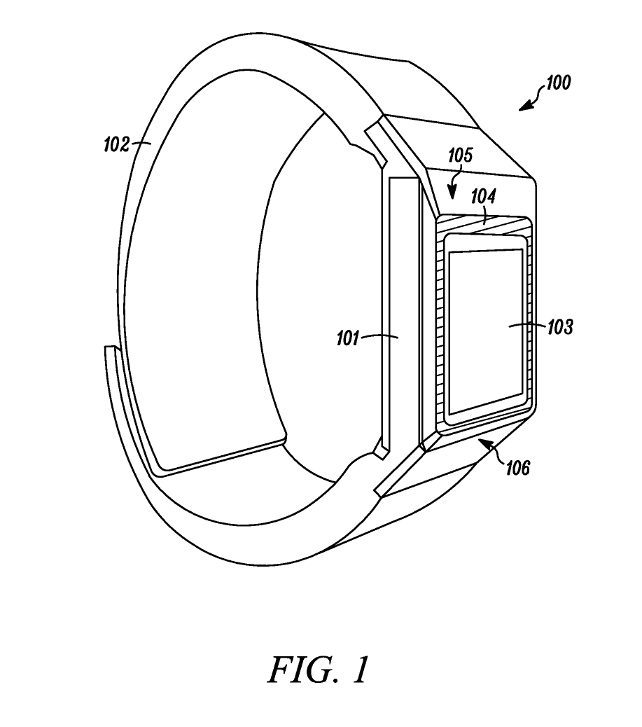

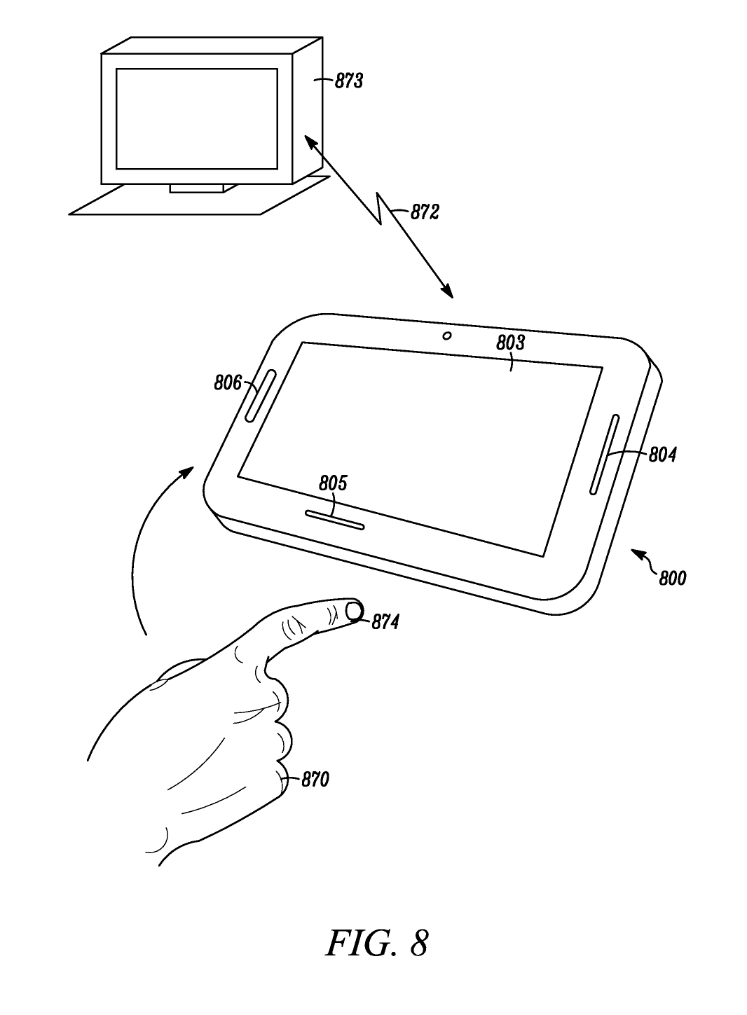

Turning now to FIG. 1, illustrated therein is one embodiment of an electronic device 100 configured in accordance with one or more embodiments of the invention. The explanatory electronic device 100 of FIG. 1 is configured as a wearable device, as wearable electronic devices are well suited for embodiments of the invention due to their smaller user interfaces and displays. However, as will be shown in FIGS. 8-10 below, other electronic devices are equally suited to the visible, audible, and tactile feedback systems described herein.

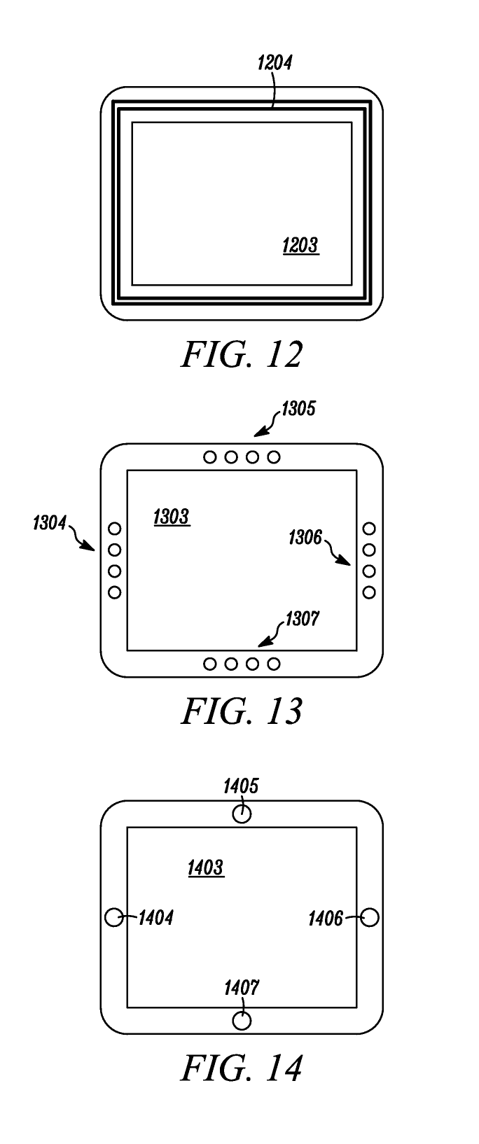

In FIG. 1, the electronic device includes an electronic module 101 and a strap 102 that are coupled together to form a wrist wearable device. The illustrative electronic device 100 of FIG. 1 has a touch sensitive display 103 that forms a user input operable to detect gesture or touch input, a control circuit operable with the touch sensitive display 103, and a visible output 104 that is proximately disposed with the touch sensitive display 103. The visible output 104 of FIG. 1 is formed from a series of lighted segments arranged as a light indicator that borders the touch sensitive display 103. In this illustrative embodiment, the light indicator is configured as a ring that surrounds the touch sensitive display. While surrounding the user interface is one configuration for the visible output 104, others will be obvious to those of ordinary skill in the art having the benefit of this disclosure. For instance, several other configurations are shown in FIGS. 12-17 below.

The electronic device 100 can be configured in a variety of ways. For example, in one embodiment the electronic device 100 includes a mobile communication circuit, and thus forms a voice or data communication device, such as a smart phone. Other communication features can be added, including a near field communication circuit for communicating with other electronic devices, as will be shown in FIG. 8 below. Infrared sensors can be provided for detecting gesture input when the user is not “in contact” with the touch sensitive display 103. One or more microphones can be included for detecting voice or other audible input. The electronic device 100 of FIG. 1 has an efficient, compact design with a simple user interface configured for efficient operation with one hand (which is advantageous when the electronic device 100 is worn on the wrist).

In one or more embodiments, in addition to the touch sensitive input functions offered by the touch sensitive display 103, the electronic device 100 can be equipped with an accelerometer, disposed within the electronic module 101 and operable with the control circuit, that can detect movement. Such a motion detector can also be used as a gesture detection device. Accordingly, when the electronic device 100 is worn on a wrist, the user can make gesture commands by moving the arm in predefined motions. Additionally, the user can deliver voice commands to the electronic device 100 via the microphones (where included).

When a user delivers gesture input to the electronic module 101, the control circuit is configured to actuate the visible output 104 by selectively illuminating one or more of the lighted segments. When the visible output 104 illuminates, the user understands that electronic module 101 has received the gesture input. Illustrating by example, in one embodiment piezoelectric transducers can be placed beneath a cover layer of the touch sensitive display 103. When the cover layer is pressed for a short time, e.g., less than two seconds, the control circuit can detect compression of the piezoelectric transducers as a predefined gesture, e.g., a gesture used to power on and off the electronic device 100. Accordingly, the control circuit may cause the visible output 104 to emit a predetermined color, such as green, on power up, and another predetermined color, such as red, on power down. When the cover layer can be pressed for a longer time, e.g., more than two seconds, the control circuit can be configured to perform a special function, such as transmission of a message. Accordingly, the control circuit can be configured to cause the visible output 104 to emit yet another predetermined color, such as yellow.

When the touch sensitive display 103 is configured with a more conventional touch sensor, such as a capacitive sensor having transparent electrodes disposed across the surface of the touch sensitive display 103, control input can be entered with more complex gestures. For instance, in some embodiments a single swiping action across the surface of the touch sensitive display 103 can be used to scroll through lists or images being presented on the touch sensitive display 103. In such embodiments, the control circuit can be configured to actuate the visible output 104 such that light emitted from the visible output 104 mimics a gesture motion of the gesture input detected by the touch sensitive display 103. If the swiping action moves from right to left across the touch sensitive display 103, the control circuit may cause a first segment 105 oriented substantially parallel with the gesture's direction to illuminate from right to left. Similarly, another segment 106 oriented substantially parallel with the gesture's direction can be illuminated. Where the touch sensitive display 103 is equipped with a force sensor, the intensity of light or the depth of color can be varied as a function of force.

The control circuit can also be configured to actuate other feedback devices in conjunction with actuation of the visible output 104. For example, the control circuit can be configured to actuate an audio output when actuating the visible output 104 to deliver sound to the user as described above. Additionally, the control circuit can be configured to actuate a tactile output when actuating the visible output 104 as well. When operating in conjunction with the piezoelectric devices as described above, the control circuit can fire the piezoelectric devices to deliver intelligent alerts, acoustics, and haptic feed back in addition to actuating the visible output 104.

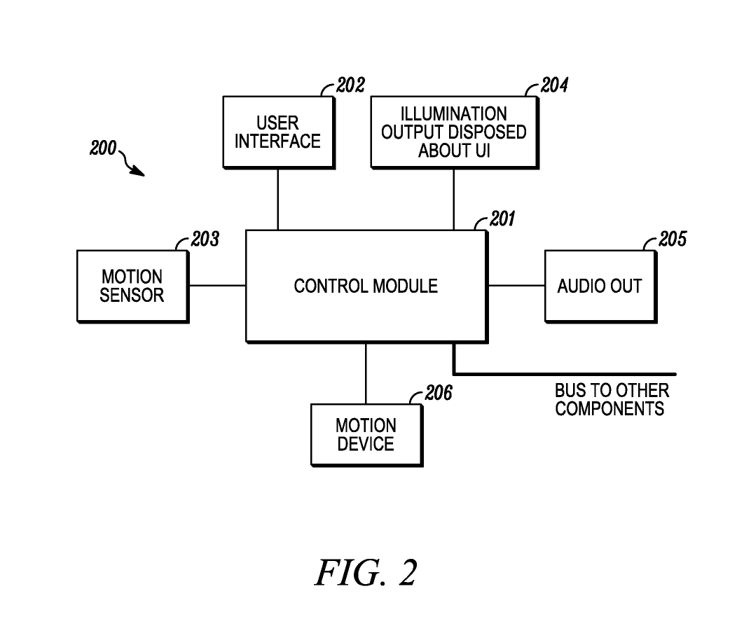

Turning now to FIG. 2, illustrated therein is a schematic block diagram 200 illustrating some of the internal components of the electronic device (100) of FIG. 1. It will be clear to those of ordinary skill in the art having the benefit of this disclosure that additional components and modules can be used with the components and modules shown. The illustrated components and modules are those used for providing feedback in accordance with one or more embodiments of the invention. Further, the various components and modules different combinations, with some components and modules included and others omitted. The other components or modules can be included or excluded based upon need or application.

A control circuit 201 is coupled to a user interface 202, which may include a display, a touch-sensitive display, a touch-pad, or other input and/or output device. The control circuit 201 is also operable with an output device 204, which in one embodiment is a visible output. In other embodiments the output device 204 is a combination of visible output and one or more of an audio output or tactile output.

The control circuit 201 can be operable with a memory. The control circuit 201, which may be any of one or more microprocessors, programmable logic, application specific integrated circuit device, or other similar device, is capable of executing program instructions and methods described herein. The program instructions and methods may be stored either on-board in the control circuit 201, or in the memory, or in other computer readable media coupled to the control circuit 201. The control circuit 201 can be configured to operate the various functions of an electronic device, such as electronic device (100) of FIG. 1, and also to execute software or firmware applications and modules that can be stored in a computer readable medium, such as the memory. The control circuit 201 executes this software or firmware, in part, to provide device functionality. The memory may include either or both static and dynamic memory components, may be used for storing both embedded code and user data. One suitable example for control circuit 201 is the MSM7630 processor manufactured by Qualcomm, Inc. The control circuit 201 may operate one or more operating systems, such as the Android™ mobile operating system offered by Google, Inc. In one embodiment, the memory comprises an 8-gigabyte embedded multi-media card (eMMC).

As noted above, when providing various forms of feedback, the control circuit 201 can be configured to execute a number of various functions. In one embodiment, the control circuit 201 is configured to actuate the output device 204 when the user interface 202 detects a gesture input received from a user. In one embodiment, where the user interface 202 comprises a touch-sensitive display, the gesture input may be detected from contact or motions of a finger or stylus across the touch-sensitive display. In another embodiment, where the user interface 202 comprises an infrared detector, the gesture input may be detected from reflections of infrared signals from a user while the user is making gestures in close proximity to the user interface 202. Where the user interface comprises a camera, the gesture input may be detected by capturing successive images of a user making a gesture in close proximity to the user interface 202.

In one embodiment, the user interface 202 comprises a display configured to provide visual output, images, or other visible indicia to a user. One example of a display suitable for use in a wearable device is 1.6-inch organic light emitting diode (OLED) device. As noted above, the display can include a touch sensor to form touch sensitive display configured to receive user input across the surface of the display. Optionally, the display can also be configured with a force sensor as well. Where configured with both a touch sensor and force sensor, the control circuit 201 can determine not only where the user contacts the display, but also how much force the user employs in contacting the display. Accordingly, the control circuit 201 can be configured to alter the output of the output device 204 in accordance with force, direction, duration, and motion. For instance, color depth can be increased with the amount of contact force.

The touch sensor of the user interface 202, where included, can include a capacitive touch sensor, an infrared touch sensor, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., control circuit 201 or another display specific control circuit, to detect an object in close proximity with—or touching—the surface of the display, a touch-pad or other contact area of the device, or designated areas of the housing of the electronic device. The capacitive sensor performs this operation by establishing electric field lines between pairs of capacitive sensors and then detecting perturbations of those field lines. The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques. For example, commonly assigned U.S. patent application Ser. No. 11/679,228, entitled “Adaptable User Interface and Mechanism for a Portable Electronic Device,” filed Feb. 27, 2007, which is incorporated herein by reference, describes a touch sensitive display employing a capacitive sensor.

Where included, the force sensor of the user interface 202 can also take various forms. For example, in one embodiment, the force sensor comprises resistive switches or a force switch array configured to detect contact with the user interface 202. An “array” as used herein refers to a set of at least one switch. The array of resistive switches can function as a force-sensing layer, in that when contact is made with either the surface of the user interface 202, changes in impedance of any of the switches may be detected. The array of switches may be any of resistance sensing switches, membrane switches, force-sensing switches such as piezoelectric switches, or other equivalent types of technology. In another embodiment, the force sensor can be capacitive. One example of a capacitive force sensor is described in commonly assigned, U.S. patent application Ser. No. 12/181,923, filed Jul. 29, 2008, published as US Published Patent Application No. US-2010-0024573-A1, which is incorporated herein by reference.

In yet another embodiment, piezoelectric sensors can be configured to sense force upon the user interface 202 as well. For example, where coupled with the lens of the display, the piezoelectric sensors can be configured to detect an amount of displacement of the lens to determine force. The piezoelectric sensors can also be configured to determine force of contact against the housing of the electronic device rather than the display or other object.

In one embodiment, the user interface 202 includes one or more microphones to receive voice input, voice commands, and other audio input. In one embodiment, a single microphone can be used. Optionally, two or more microphones can be included to detect directions from which voice input is being received. For example a first microphone can be located on a first side of the electronic device for receiving audio input from a first direction. Similarly, a second microphone can be placed on a second side of the electronic device for receiving audio input from a second direction. The control circuit 201 can then select between the first microphone and the second microphone to detect user input.

In yet another embodiment, gesture input is detected by light. The user interface 202 can include a light sensor configured to detect changes in optical intensity, color, light, or shadow in the near vicinity of the user interface 202. The light sensor can be configured as a camera or image-sensing device that captures successive images about the device and compares luminous intensity, color, or other spatial variations between images to detect motion or the presence of an object near the user interface. Such sensors can be useful in detecting gesture input when the user is not touching the overall device. In another embodiment, an infrared sensor can be used in conjunction with, or in place of, the light sensor. The infrared sensor can be configured to operate in a similar manner, but on the basis of infrared radiation rather than visible light. The light sensor and/or infrared sensor can be used to detect gesture commands

Motion detection devices 203 can also be included to detect gesture input. In one embodiment, an accelerometer can be included to detect motion of the electronic device. The accelerometer can also be used to determine the spatial orientation of the electronic device in three-dimensional space by detecting a gravitational direction. In addition to, or instead of, the accelerometer, an electronic compass can be included to detect the spatial orientation of the electronic device relative to the earth's magnetic field. Similarly, the motion detection devices 203 can include one or more gyroscopes to detect rotational motion of the electronic device. The gyroscope can be used to determine the spatial rotation of the electronic device in three-dimensional space. Each of the motion detection devices 203 can be used to detect gesture input.

An audio output 205 can be included to provide aural feedback to the user. For example, one or more loudspeakers can be included to deliver sounds and tones when gesture input is detected. Alternatively, when a cover layer of a display or user interaction surface is coupled to piezoelectric transducers, the cover layer can be used as an audio output device as well. The inclusion of the audio output 205 allows both visible and audible feedback to be delivered when gesture input is detected. The control circuit 201 can be configured to actuate the audio output 205 when actuating the visible output device 204.

A motion generation device 206 can be included for providing haptic feedback to a user. For example, a piezoelectric transducer or other electromechanical device can be configured to impart a force upon the user interface 202 or a housing of the electronic device to provide a thump, bump, vibration, or other physical sensation to the user. The inclusion of the motion generation device 206 allows both visible and tactile feedback to be delivered when gesture input is detected. The control circuit 201 can be configured to actuate the motion generation device 206 to deliver a tactile output when actuating the visible output device 204. Of course, the output device 204, the audio output 205, and motion generation device 206 can be used in any combination.

In one embodiment, the control circuit 201 is configured to detect a predetermined characteristic of a gesture input. Examples include gesture duration, gesture intensity, gesture proximity, gesture accuracy, gesture contact force, or combinations thereof. Where the control circuit 201 detects the predetermined characteristic, it can actuate the output device 204 in a manner that corresponds with, or otherwise indicates, that the predetermined characteristic was received. For example, where the predetermined characteristic is gesture duration, the control circuit 201 can be configured to actuate the output device 204 with an output duration corresponding to the gesture duration. If the gesture lasts for two seconds, the control circuit 201 can actuate the output device 204 for two seconds, and so forth.

Where the predetermined characteristic is gesture intensity, the control circuit 201 can be configured to actuate the output device 204 with an output intensity corresponding to the gesture intensity. For example, the light emitted from the output device 204 can be brighter for intense inputs and dimmer for less intense inputs. Where the predetermined characteristic is gesture proximity or gesture accuracy, the control circuit 201 can be configured to actuate the output device 204 with a predetermined color corresponding to the characteristic. If, for example, a user actuation target is present on a touch-sensitive display, the control circuit 201 may be configured to turn the output device 204 green when the user accurately selects the user actuation target and red otherwise.

Alternatively, where the user interface 202 is configured to detect gesture proximity, the control circuit 201 can be configured to alter a color of the output device in accordance with one or more characteristics of the gesture input. The control circuit 201 may turn the output device 204 green when the user is very close to the user interface 202, yellow when the user is farther from the user interface 202, and red when the user is still farther from the user interface 202. These examples are explanatory only, as others will be obvious to those of ordinary skill in the art having the benefit of this disclosure. The control circuit 201 can be configured to alter one or more of an intensity of the light from the output device 204, a duration of the light from the output device 204, a direction of the light from the output device 204, i.e., whether the light sources are lit sequentially from left to right or right to left, a color of the light from the output device 204, or combinations thereof in accordance with a predetermined characteristic of the gesture input detected by the user interface 202.

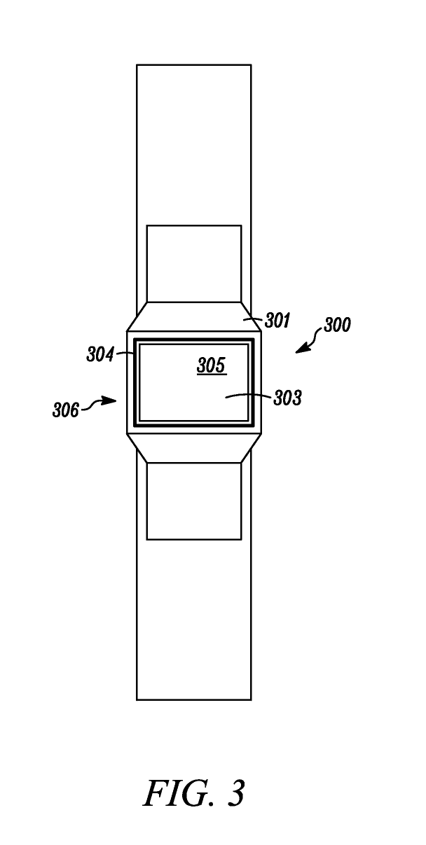

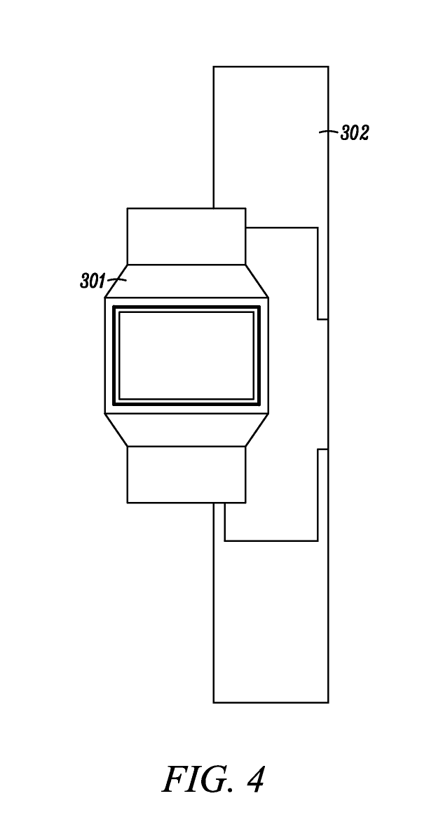

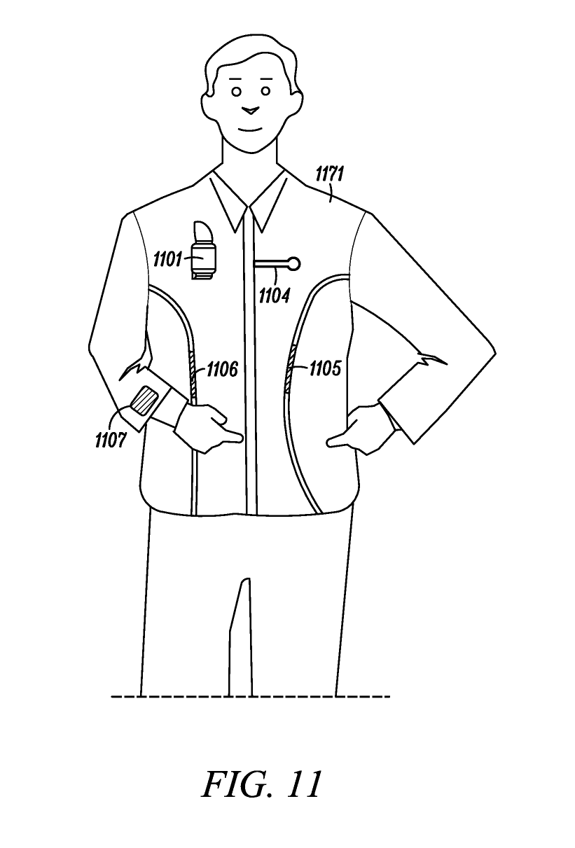

Turning now to FIG. 3, illustrated therein is an alternate electronic device 300 configured with a light indicator 304 as a visible output in accordance with one or more embodiments of the invention. The electronic device 300 of FIG. 3 is configured as a wristwatch having an active strap 302 and a detachable electronic module 301. As shown in FIG. 4, the detachable electronic module 301 can be selectively detached from the active strap 302 so as to be used as a stand alone electronic device. For example, as will be shown in FIG. 11 below, the detachable electronic module 301 can be detached from the active strap 302 and worn on a jacket. In this illustrative embodiment, both the active strap 302 and the detachable electronic module 301 are “active” devices. An active device refers to a device that includes a power source and electronic circuitry and/or hardware. Active devices can include control circuits or processors as well.

In one or more embodiments, the detachable electronic module 301 can be detached from the active strap 302 so that it can be coupled with, or can communicate or interface with, other devices. For example, where the detachable electronic module 301 includes wide area network communication capabilities, such as cellular communication capabilities, the detachable electronic module 301 may be coupled to a folio or docking device to interface with a tablet-style computer. In this configuration, the detachable electronic module 301 can be configured to function as a modem or communication device for the tablet-style computer. In such an application, a user may leverage the large screen of the tablet-style computer with the computing functionality of the detachable electronic module 301, thereby creating device-to-device experiences for telephony, messaging, or other applications. The detachable nature of the detachable electronic module 301 serves to expand the number of experience horizons for the user.

Turning back to FIG. 3, in one embodiment the detachable electronic module 301 includes a display 303 configured to provide visual output to a user. In this illustrative embodiment, the display 303 serves as a touch-sensitive interface. The light indicator 304 is disposed beside the display 303. In the illustrative embodiment, the light indicator 304 borders and surrounds the display 303.

The display 303 of FIG. 3 includes a cover layer 305. The cover layer 305 serves as a fascia for the display 303 and protects the underlying display 303 from dust and debris. The cover layer 305 can be manufactured from thermoplastics, glass, reinforced glass, or other materials. In the illustrative embodiment of FIG. 3, the cover layer 305 is configured as a light guide operable to translate light received from the light indicator 304 output across at least a portion of the cover layer 305. Thus, if the control circuit of the detachable electronic module 301 illuminates a left side 306 of the light indicator 304 in response to the display 303 detecting user input, the cover layer 305 can translate light from the left side 306 across a portion of the display 303 to create a glowing effect. Light guides provide additional visibility to the user of the feedback from the light indicator 304.

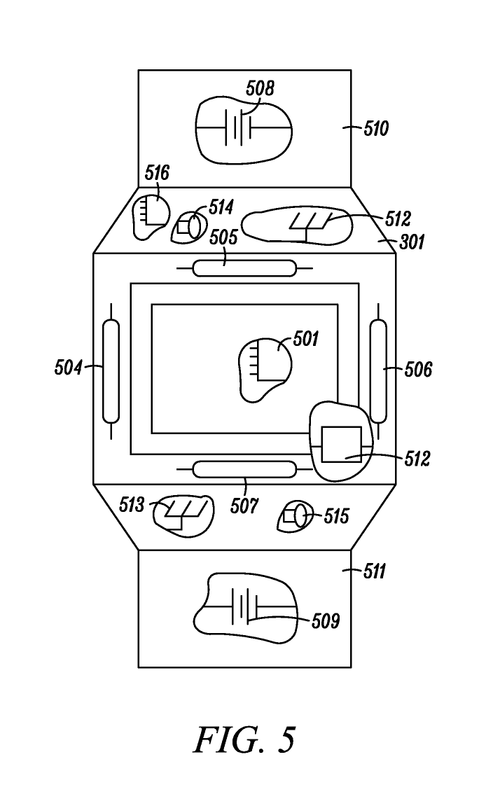

Turning now to FIG. 5, illustrated therein is a cut-away view of the detachable electronic module 301 from FIG. 3 that illustrates some of the components disposed within the housing of the detachable electronic module 301. These components include lighted segments 504,505,506,507 that form the light indicator (304), a control circuit 501, power sources, microphones, communication circuits, and other components.

The power sources of this illustrative embodiment comprise a first cell 508 disposed in a first electronic module extension 510 and a second cell 509 disposed in a second electronic module extension 511. Other electrical components, such as the control circuit 501, are disposed within a central housing of the detachable electronic module 301, with the exception of any conductors or connectors, safety circuits, or charging circuits used or required to deliver energy from the first cell 508 and second cell 509 to the electronic components disposed within the central housing. In this illustrative embodiment, the first cell 508 and second cell 509 each comprise 400 mAh lithium cells. Where the detachable electronic module 301 is configured for communication with both wide area networks, e.g., cellular networks, and local area networks, e.g., WiFi networks, both the first cell 508 and the second cell 509 can be included. However, in some embodiments where only local area network communication or no communication capability is included, one of the first cell 508 or second cell 509 may be omitted. The first cell 508 and second cell 509 can be coupled in parallel to provide higher peak pulse currents. Alternatively, the first cell 508 and the second cell 509 can be coupled in series when there is no high current demand One or more switches can be used to selectively alter the coupling of the first cell 508 and second cell 509 in the series/parallel configurations.

A mobile communication circuit 512 can be disposed at a first end of the detachable electronic module 301. A near field communication circuit 513 can be disposed on another end of the detachable electronic module 301 opposite the mobile communication circuit 512. The illustrative embodiment of FIG. 5 includes both microphones 514,515 and an infrared gesture detector 516. The microphones 514,515 in this embodiment comprise a first microphone 514 disposed on a first side of the detachable electronic module 301 and a second microphone 515 disposed on a second side of the detachable electronic module 301 that is opposite the first side. The infrared gesture detector 516, which can detect user gestures when the user is not in contact with the detachable electronic module 301, emits and receives infrared signals. The touch-sensitive user interface of the display 503, the microphones 514,515, and the infrared gesture detector 516 can each be used, alone or in combination, to detect gesture input. Once this occurs, the control circuit 501 can cause one or more of the lighted segments 504,505,506,507 forming the light indicator (304) to emit light.

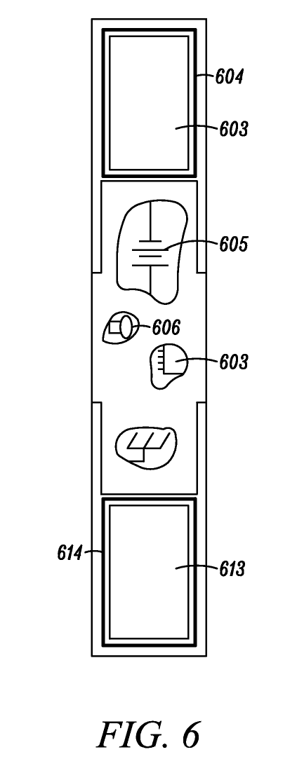

Gesture detectors and visible outputs configured in accordance with embodiments of the present invention need not always be used with “smart” devices. Turning now to FIG. 6, illustrated therein is an active strap 600 configured in accordance with one or more embodiments of the invention. The active strap 600 includes a power source and electrical hardware components. The active strap 600 can be a health monitoring device, an exercise-monitoring device, a gaming device, a media player, or any number of other devices. The active strap 600 of FIG. 6 is detachable from an electronic module, such as that shown in FIG. 5. However, it will be clear to those of ordinary skill in the art having the benefit of this disclosure that the active strap 600 can be configured as a stand-alone device as well.

In this embodiment, the active strap 600 includes a control circuit 601 operable with one or more touch-sensitive surfaces 603,613. Here, the touch-sensitive surfaces 603,613 are dedicated input devices. Displays or other data presentation devices can be included as required by a particular application. The control circuit 601 can be operable with a memory 602. The control circuit 601, which may be any of one or more microprocessors, programmable logic, application specific integrated circuit device, or other similar device, is capable of executing program instructions associated with the functions of the active strap 600, including illuminating the light indicators 604,614 when the touch-sensitive surfaces 603,613 detect touch input from a user. The program instructions and methods may be stored either on-board in the control circuit 601, or in the memory, or in other computer readable media coupled to the control circuit 601.

Where the active strap 600 includes a display, in one embodiment, the display comprises one or more flexible display devices. For example, flexible touch-sensitive displays can be substituted for the touch-sensitive surfaces 603,613 of FIG. 6. Since the active strap 600 can be configured as a wristband or a wristwatch-type wearable device, flexible displays disposed on the active strap 600 can “wrap” around the wearer's wrist without compromising operational performance. While the display can include non-flexible displays as well, the inclusion of flexible display devices not only increases comfort for the wearer but also allows the display to be larger as well. The display can also be configured with a force sensor. Where configured with both, the control circuit 601 can determine not only where the user contacts the display or touch-sensitive surfaces 603,613, but also how much force the user employs in contacting the display or touch-sensitive displays 603,613.

A battery 605 or other energy source can be included to provide power for the various components of the active strap 600. In one or more embodiments, the battery 605 is selectively detachable from the active strap 600. Charging circuitry can be included in the active strap 600 as well. The charging circuitry can include overvoltage and overcurrent protection. In one embodiment, the battery 605 is configured as a flexible lithium polymer cell.

One or more microphones 606 can be included to receive voice input, voice commands, and other audio input. A single microphone can be included. Optionally, two or more microphones can be included. Piezoelectric devices can be configured to both receive input from the user and deliver haptic feedback to the user.

When the touch-sensitive surfaces detect touch-input from a user, the control circuit 601 can be configured to illuminate the light indicators 604,614 disposed about the touch-sensitive surfaces 603,613, thereby providing feedback to the user. Note that where the active strap 600 is coupled to a detachable electronic module (500), the control circuit 601 of the active strap 600 can be configured to be operable with the control circuit (501) of the detachable electronic module (500) such that when the user delivers input to a user interface disposed on the detachable electronic module, the light indicators 604,614 on the active strap 600 can be configured to illuminate along with, or instead of, and feedback devices disposed along the detachable electronic module (500).

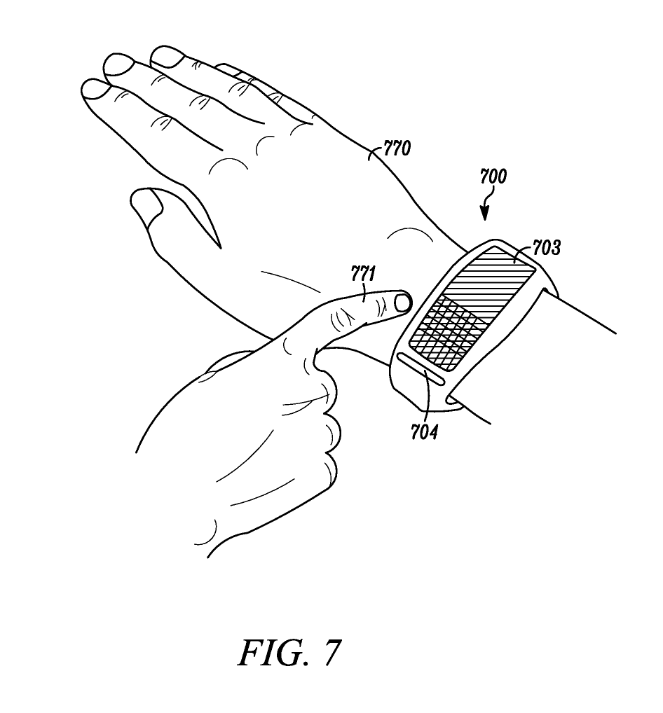

Now that the various components of various systems have been described, a few use cases will assist in making operational features of various embodiments more clear. Beginning with FIG. 7, a user 770 is wearing an electronic device 700 configured in accordance with one or more embodiments of the invention. The illustrative electronic device 700 is a fitness monitor to be used during exercise. It should be noted that the overall size of the touch-sensitive display 703 on this device is not substantially larger than the user's finger 771. Consequently, when the user 770 touches the touch-sensitive display 703, the finger substantially covers a large portion of the touch-sensitive display 703.

To let the user know whether the interaction with the touch-sensitive display 703 has been successfully, a visible output 704, configured here as a light indicator having one or more lighted segments and bordering a single side of the touch-sensitive display 703 is illuminated. As noted above, if the user 770 makes a more complex gesture, a control circuit disposed within the electronic device 700 can be configured to detect one or more predefined characteristics of the gesture and accordingly adjust how the visible output 704 operates. The control circuit can alter output duration, output intensity, output color, and so forth.

Turning to FIG. 8, illustrated therein is a unique use case enabled by embodiments of the present invention. A user 870 is making a presentation using a tablet electronic device 800. The tablet device has a touch-sensitive display 803 that also includes infrared sensing capabilities to form a gesture input capable of detecting user gesture input 871 that are near, but not touching the tablet electronic device 800.

As shown, the tablet electronic device 800 includes one or more light indicators 804,805,806 disposed about the touch-sensitive display 803. In this illustrative embodiment, the light indicators 804,805,806 comprise three lighted segments bordering three sides of the display.

The tablet electronic device 800 also includes near field communication circuitry capable of sending one or more control signals 872 corresponding to the gesture input 871 to a remote electronic device 873. The remote electronic device 873 of this illustrative embodiment is a projection screen capable of being viewed by an audience. Accordingly, the user 870 can make gestures about the tablet electronic device 800 to control images projected on the remote electronic device 873.

As it can be advantageous for the user 870 to look at the audience rather than at either the tablet electronic device 800 or the remote electronic device 873, the user needs a way to see—via only peripheral vision—not only that his gesture input 871 is being received by the tablet electronic device 800 to control the presentation, but also that his gesture input 871 is being received accurately. To do this, the tablet electronic device 800 is configured to control the light emitted from the light indicators 804,805,806 so as to mimic the gesture input 871 detected with the user interface.

As shown in FIG. 8, the user is making a clock-wise circular motion as the gesture input 871. Accordingly, the control circuit disposed within the tablet electronic device 800 can fire the light indicators 804,805,806 in a sequential fashion with, for example, light indicator 806 being fired first, light indicator 804 being fired second, and light indicator 805 being fired third. Moreover, the control circuit can fire these light indicators 804,805,806 at a rate, and with a duration, that approximates the speed of the user's finger 874 as it passes through the air. The user 870 thus has the “no-look pass” peripheral detection that the gesture input 871 has been not only received by the tablet electronic device 800, but also that it has been received accurately.

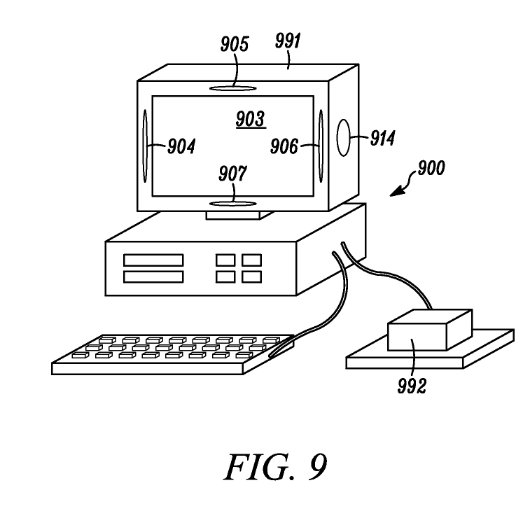

Turning now to FIGS. 9-11, illustrated therein are some alternate electronic devices that each include visible and/or audible output systems configured in accordance with one or more embodiments of the invention. Beginning with FIG. 9, illustrated therein is a desktop computer 900 having a monitor 991 and a mouse 992. A user can deliver input to the desktop computer 900 by clicking or otherwise manipulating the mouse. Since the resolution on desktop computer monitors can be very small, to increase the speed at which the user can work, the desktop computer is equipped with four visual outputs 904,905,906,907 bordering the display 903 of the monitor 991 on four sides. Additionally, the monitor is equipped with audio output devices 914 capable of delivering sound to the user.

When the user manipulates the mouse 992 by clicking or motion, a control circuit within the desktop computer is configured to actuate the visual outputs 904,905,906,907 and audio output devices 914 simultaneously. This feedback allows the user to peripherally understand that the input was received.

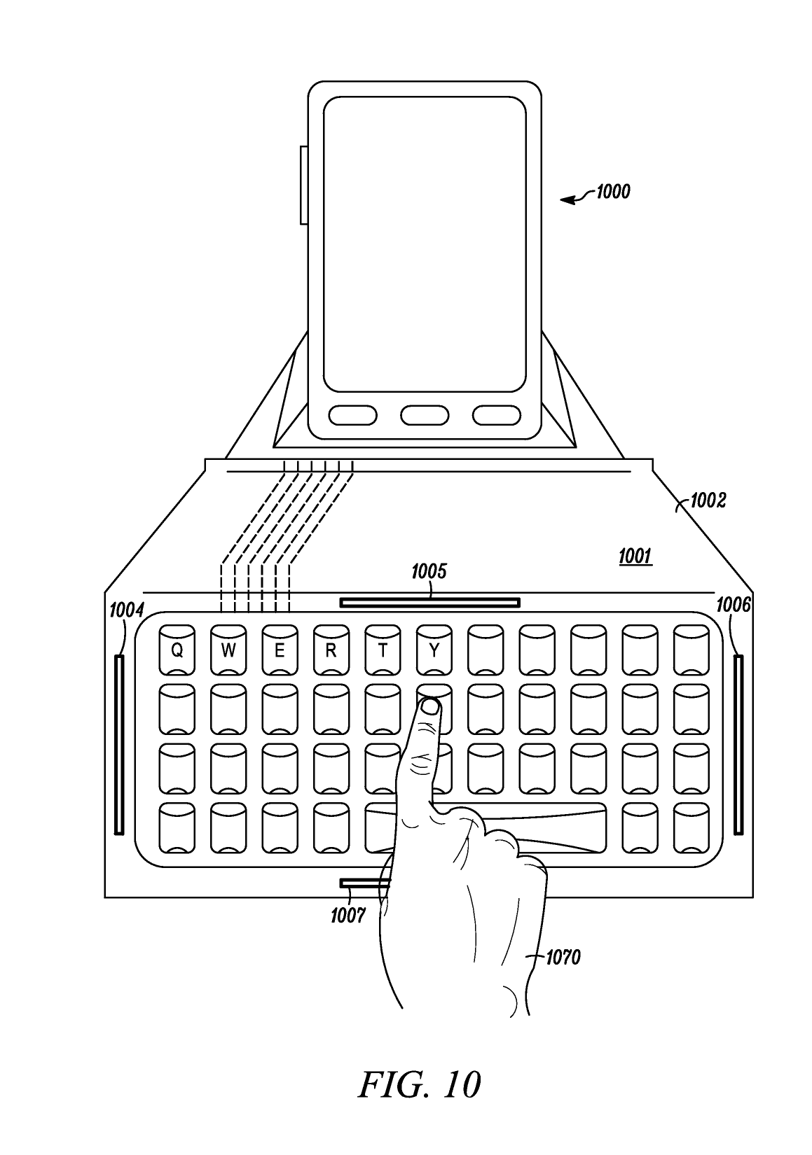

FIG. 10 illustrates a peripheral keyboard 1001 configured to be operable with an electronic device 1000. In this illustrative embodiment, the peripheral keyboard 1001 is situated in a folio with the electronic device 1000. The peripheral keyboard 1001 is configured with non-moving keys, and can deliver a haptic response to a user 1070. Such a peripheral keypad is disclosed in commonly assigned, co-pending U.S. application Ser. No.______, entitled “User Interface with Localized Haptic Response,” Attorney Docket No. CS38136, filed______, which is incorporated herein by reference.

To provide the user with visual feedback, in addition to haptic feedback, when a key is pressed, the peripheral keyboard 1001 is equipped with four visual outputs 1004,1005,1006,1007 bordering the peripheral keyboard 1001 on four sides. When the user 1070 actuates one of the non-moving keys, a control circuit within the peripheral keyboard 1001 is configured to actuate the visual outputs 1004,1005,1006,1007 and haptic output devices simultaneously. This feedback allows the user to peripherally understand that the input was received.

As noted above, predetermined characteristics corresponding to user input can be detected as well. One predetermined characteristic corresponding to a peripheral keyboard 1001 is a multi-key press. One common example is pressing “ctrl-ALT-del” simultaneously. In one embodiment, the control circuit can alter the output from the visual outputs 1004,1005,1006,1007 such that the output corresponds to the predetermined characteristic. Since ctrl-ALT-del comprises a three-key stroke, the control circuit may elect to actuate only three of the visual outputs 1004,1005,1006. The user 1070 thus instantly knows that three keys have been actuated.

FIG. 11 illustrates a detachable electronic module 1101 being worn as a wearable device coupled to a wearer's jacket 1171. The wearer's jacket 1171 is also an electronic device, and includes a plurality of visual indicators 1104,1105,1106,1107 disposed thereon. When the control circuit of the detachable electronic module 1101 detects gesture input, be it by motion of the wearer or touch input on the detachable electronic module, the control circuit can deliver control signals to the wearer's jacket to illuminate one or more of the visual indicators 1104,1105,1106,1107 with a duration, intensity, color, direction, or other characteristic mimicking the gesture input.

FIGS. 12-17 illustrate just a few of the many variations that visible output devices can take in accordance with one or more embodiments of the invention. Others will be obvious to those of ordinary skill in the art having the benefit of this disclosure.

FIG. 12 illustrates a visual output 1204 configured as a ring that encircles the display 1203. FIG. 13 employs four sets 1304,1305,1306,1307 of lighted segments, with each set 1304,1305,1306,1307 bordering a single side of the display 1303.

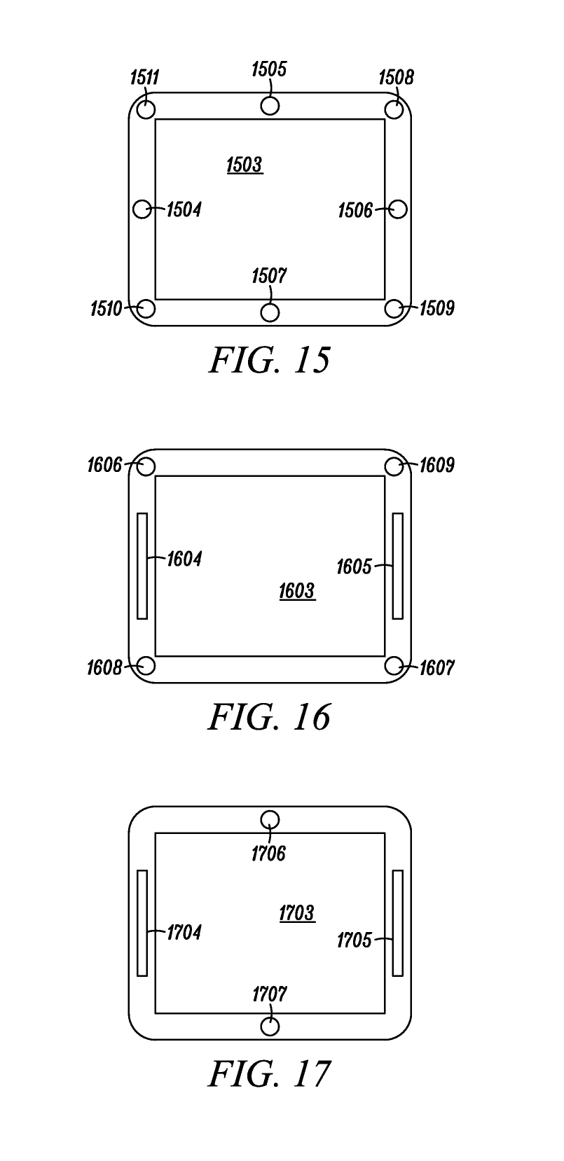

FIG. 14 employs only a single lighted segment 1404,1405,1406,1407 on each side of the display 1403. FIG. 15 employs eight lighted segments 1504,1505,1506,1507,1508,1509,1510,1511 surrounding the display 1503. FIG. 16 employs a combination of linear light segments 1604,1605 and lighted segments 1606,1607,1608,1609, each bordering the display 1603. FIG. 17 employs a slightly different combination of linear light segments 1704,1705 and lighted segments 1706,1707 each bordering the display 1703.

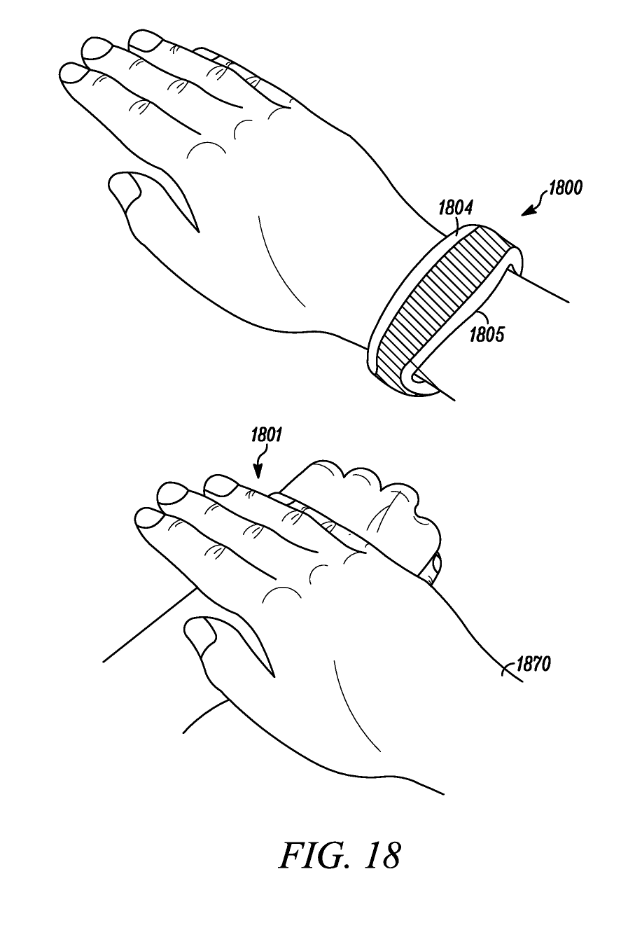

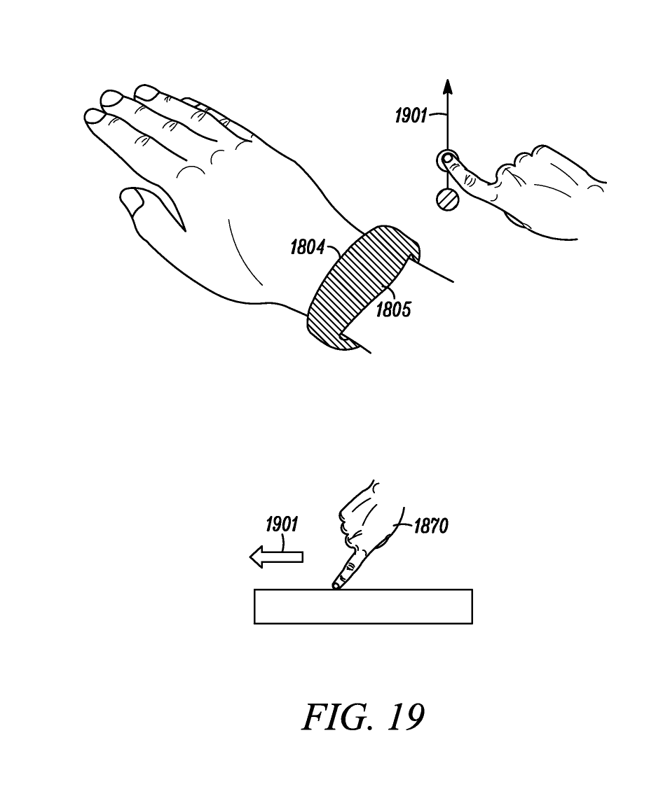

Additional use cases are shown in FIGS. 18-22, each illustrating how a predetermined characteristic of a gesture input can be used to deliver a predefined output to a user. Beginning with FIG. 18, a user “taps” 1801 a wearable electronic device 1800. A control circuit disposed within the wearable electronic device 1800 has been programmed to recognize a tap 1801 as a predetermined characteristic that causes a power-up operation. Accordingly, the control circuit causes both a first light indicator 1804 and a second light indicator 1805 to come on. By contrast, in FIG. 19, the user 1870 is making a sliding gesture 1901 to the right. The control circuit recognizes the sliding gesture 1901 as a predetermined characteristic to which it should mimic. Accordingly, the control circuit causes the second light indicator 1805 to go off while keeping the first light indicator 1804 on. The user 1870 thus knows the sliding gesture 1901 was performed accurately because the light output has moved in the direction of the sliding gesture 1901.

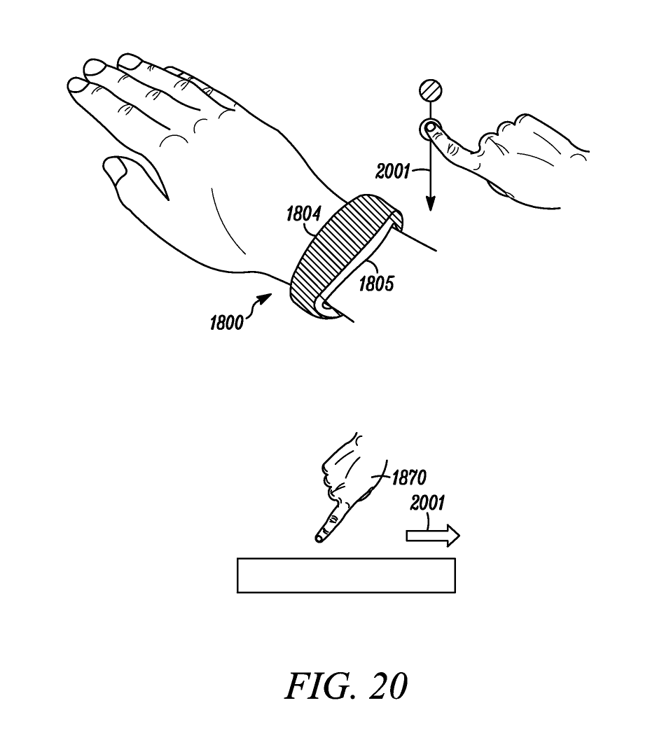

The opposite is true in FIG. 20. The user 1870 is making a sliding gesture 2001 to the down. The control circuit recognizes the sliding gesture 2001 as a predetermined characteristic to which it should mimic Since the wearable electronic device 1800 is being held with the second light indicator 1805 towards the bottom, as detected by the motion detector of the wearable electronic device 1800, the control circuit causes the first light indicator 1804 to go off while turning the second light indicator 1805 on. The user 1870 thus knows the sliding gesture 2001 was performed accurately because the light output has moved in the direction of the sliding gesture 2001.

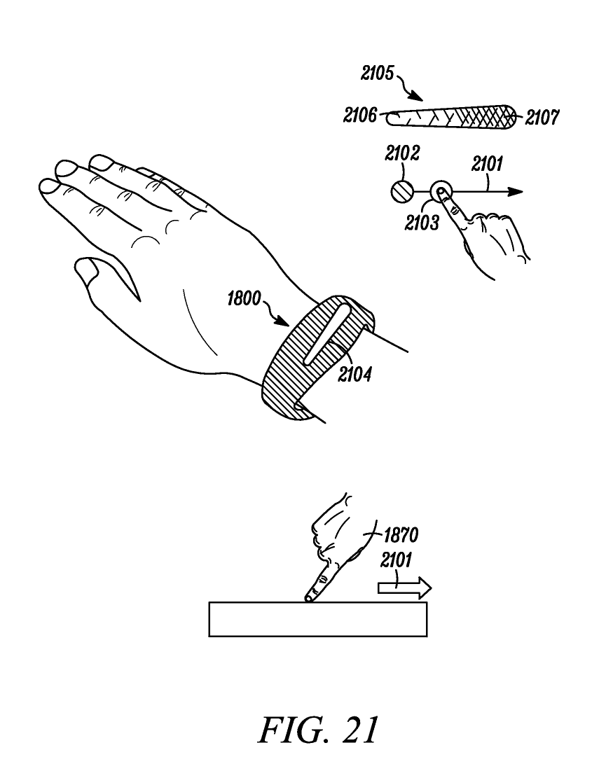

In FIG. 21, the user 1870 is making a similar sliding gesture 2101 to the right. However, this sliding gesture 2101 begins 2102 with a light application of force and ends 2103 with a heavier application of force. To mimic this sliding gesture 2101, the control circuit actuates a third light indicator 2104 capable of varying intensity, color, or combinations thereof. As shown at view 2105, the light output begins 2106 with a first color, first intensity, or both, and ends 2107 with more intensity, a second color, or both. Additionally, the width of the light output has become larger from beginning 2106 to end 2107 as well in this illustrative embodiment. The third light indicator 2104 has also shifted the output towards the right side of the wearable electronic device 1800.

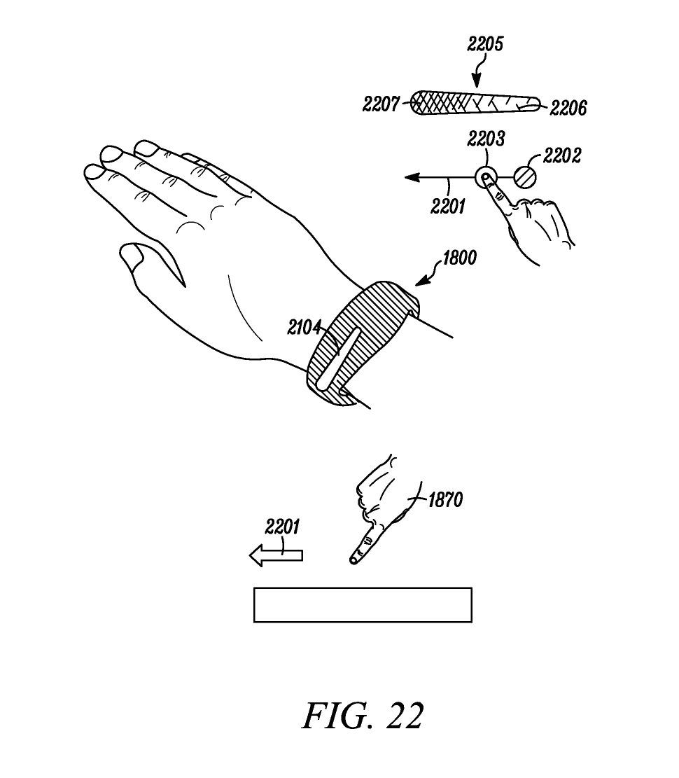

The opposite is true in FIG. 22. The user 1870 is making a sliding gesture 2201 to the left. As with FIG. 21, this sliding gesture 2201 begins 2202 with a light application of force and ends 2203 with a heavier application of force. To mimic this sliding gesture 2201, the control circuit actuates the third light indicator 2104. As shown at view 2205, the light output begins 2206 with a first color, first intensity, or both, and ends 2207 with more intensity, a second color, or both. Additionally, the width of the light output has become larger from beginning 2206 to end 2207 as well in this illustrative embodiment. The third light indicator 2204 has also shifted the output towards the right side of the wearable electronic device 1800.

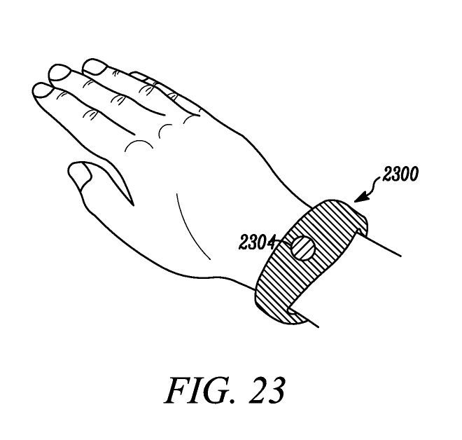

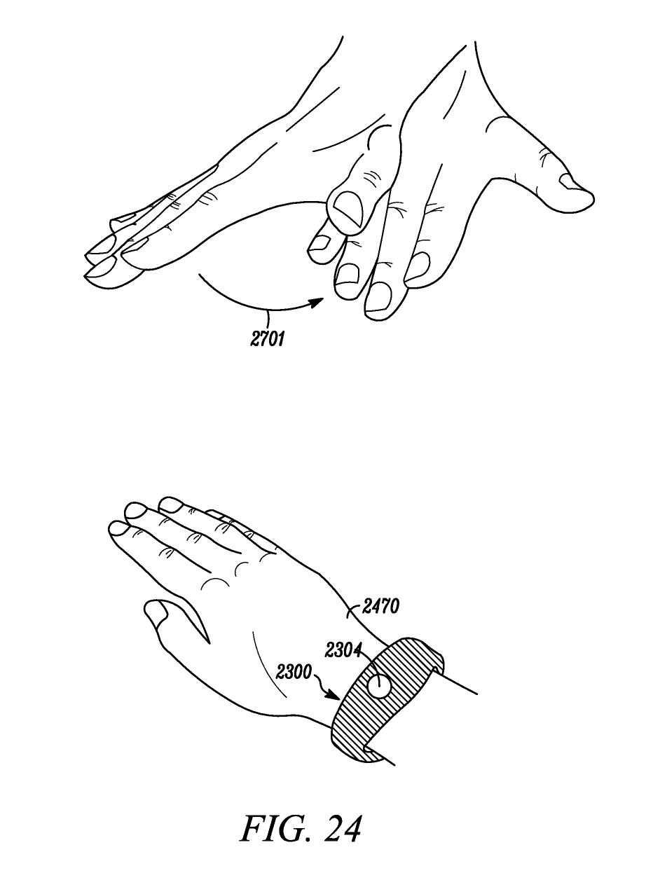

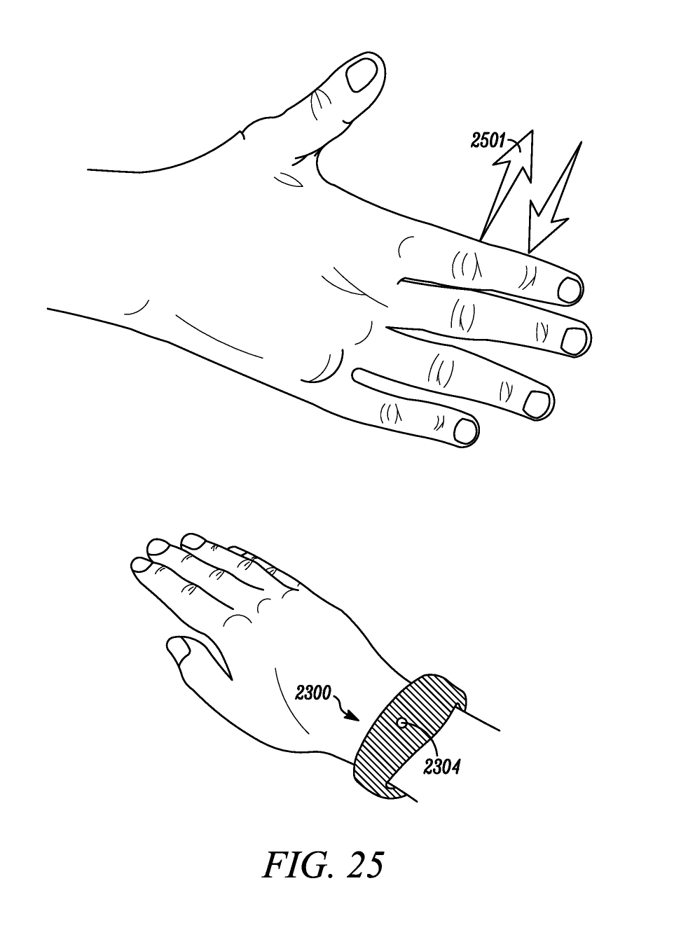

In addition to mimicking gesture inputs, in one or more embodiments the control circuit is configured to alter the operational mode of the electronic device as well. For example, turning to FIG. 23, a wearable electronic device 2300 is shown operating in a first operational mode, as indicated by a light indicator 2304 disposed on the wearable electronic device 2300. The light indicator 2304 has a first state comprises of color, intensity, and other light characteristics. At FIG. 24, the user 2470 makes a first gesture 2701, thereby transforming the wearable electronic device 2300 to a second operational mode as indicated by the light indicator 2304, which is now a different size, color, and intensity. In FIG. 25, in response to a different gesture 2501, the wearable electronic device 2300 is transformed to a third operational mode as indicated by the light indicator 2304, which is now a third size, color, and intensity.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic device, comprising:
a user interface operable to detect gesture input;
a visible output proximately disposed with the user interface; and
a control circuit operable with the user interface and the visible output;
wherein the control circuit is configured to actuate the visible output when the user interface detects the gesture input.

2. The electronic device of claim 1, wherein the user interface comprises a touch-sensitive display, wherein the visible output comprises a light indicator bordering one or more sides of the touch-sensitive display.

3. The electronic device of claim 2, wherein the light indicator surrounds the touch-sensitive display.

4. The electronic device of claim 2, wherein the light indicator comprises one or more lighted segments.

5. The electronic device of claim 4, wherein the one or more lighted segments each comprises a plurality of light indicators.

6. The electronic device of claim 1, further comprising an audio output operable with the control circuit, wherein the control circuit is configured to actuate the audio output when actuating the visible output.

7. The electronic device of claim 1, further comprising a tactile output operable with the control circuit, wherein the control circuit is configured to actuate the tactile output when actuating the visible output.

8. The electronic device of claim 1, wherein the control circuit is configured to detect a predetermined characteristic of the gesture input, wherein the predetermined characteristic comprises one or more of gesture duration, gesture intensity, gesture proximity, gesture accuracy, gesture contact force, or combinations thereof.

9. The electronic device of claim 8, wherein the control circuit is configured to actuate the visible output with an output duration corresponding to the predetermined characteristic of the gesture input detected by the user interface.

10. The electronic device of claim 8, wherein the control circuit is configured to actuate the visible output with an output intensity corresponding to the predetermined characteristic of the gesture input detected by the user interface.

11. The electronic device of claim 8, wherein the control circuit is configured to actuate the visible output with a predetermined color corresponding to the predetermined characteristic of the gesture input detected by the user interface.

12. The electronic device of claim 1, wherein the control circuit is configured to alter a color of the visible output in accordance with one or more predetermined characteristics corresponding to the gesture input detected by the user interface.

13. The electronic device of claim 1, wherein the control circuit is configured to actuate the visible output such that light emitted from the visible output mimics a gesture motion of the gesture input detected by the user interface.

14. The electronic device of claim 1, wherein the user interface comprises a cover layer, wherein the cover layer is configured as a light guide operable to translate light received from the visible output across at least a portion of the cover layer.

15. A method for input confirmation feedback from an electronic device, comprising:
detecting, with an input interface, a gesture input; and
actuating, with a control circuit, a visible output after detecting the gesture input, wherein the actuating comprises causing a light indicator disposed adjacent with, but separate from, the input interface to emit light.

16. The method of claim 15, wherein the actuating comprises controlling the light so as to mimic the gesture input detected with the input interface.

17. The method of claim 15, further comprising altering one or more of an intensity of the light, a duration of the light, a direction of the light, a color of the light, or combinations thereof in accordance with a predetermined characteristic of the gesture input detected by the input interface.

18. The method of claim 15, further comprising sending one or more control signals corresponding to the gesture input to a remote electronic device.

19. A wearable electronic device, comprising:
a touch-sensitive user interface;
a strap coupled to the touch-sensitive user interface;
a light indicator disposed beside the touch-sensitive user interface; and
a control circuit operable with the touch-sensitive user interface to illuminate the light indicator when the touch-sensitive user interface detects touch input.

20. The wearable electronic device of claim 19, further comprising a detachable electronic module having a display and being separable from the strap, wherein the touch-sensitive user interface and the light indicator are disposed along the strap.
